(19) United States
(12) Patent Application Publication
(10) Pub. No.: US 2021/0350116 A1
(43) Pub. Date: Nov. 11, 2021

(54) SYSTEM AND METHOD FOR IDENTIFYING PERSONS-OF-INTEREST

(71) Applicant: NCS PTE. LTD., Singapore (SG)

(72) Inventors: Yan Shixing, Singapore (SG); Arun Kumar Chandran, Singapore (SG)

(21) Appl. No.: 17/308,612

(22) Filed: May 5, 2021

(30) Foreign Application Priority Data
May 6, 2020 (SG) 10202004188X

(51) Int. Cl. G06K 9/00; G06F 16/587; G06K 9/62

(52) U.S. Cl. CPC G06K 9/00288; G06K 9/00778; G06K 9/6277; G06K 9/00228; G06F 16/587

(57) ABSTRACT

This document describes a system and method for identifying persons-of-interest based on images and/or information captured by image capturing devices and information provided by third party sources/databases. In particular, this document describes a system that comprises at least one set of image capturing devices that are provided at a particular location-of-interest, a remote database that is configured to receive the captured images and its associated information from the set of image capturing devices, a server and a third party database whereby the remote database, the server and the third party database are all communicatively connected together. The server is then configured to utilize information from the remote database and the third party database to identify persons-of-interest from the images of individuals that were captured by the set of image capturing devices.

### RELATED APPLICATION(S)

This application claims the benefit of Singapore Patent Application No. 10202004188X, filed on May 6, 2020, The entire contents of which is herein incorporated by reference.

### FIELD OF THE INVENTION

This invention relates to a system and method for identifying persons-of-interest based on images and/or information captured by image capturing devices and information provided by third party sources/databases. In particular, this invention relates to a system that comprises an anomaly detection module, a third party database and a person-of-interest (POI) module which are all communicatively connected together. The anomaly detection module is configured to train an anomaly detection model based on data retrieved from the third party database whereby the trained model is then subsequently used to identify anomalous patterns from datasets that are newly retrieved from the third party database. The POI module is then configured to extract from the anomalous patterns identified by the anomaly detection module, datasets associated with these anomalous patterns and information about individuals linked with these datasets. The POI modules then utilizes this information about the individuals, to obtain captured images of the individuals and identification tags associated with each of the individuals, from image capturing devices provided at a location-of-interest (LOI), whereby the identification tags are generated from the captured images of the individuals and then to identify, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

### Summary of Prior Art

Existing surveillance systems typically involve the use of surveillance devices (such as closed-circuit security video systems) to monitor activities at locations-of-interest to deter, prevent and/or detect suspicious activities or abnormal incidents that may occur. These surveillance systems typically capture and store positional and/or visual information of individuals of interest so that law enforcement officers may utilize the stored information to identify and subsequently locate these individuals in the event an abnormal incident such as a crime occurs at the location-of-interest. Presently, information about these individuals are scattered across various sources and a predominantly manual search is required to be carried out across the various information sources to identify and locate these persons-of-interest.

In order to simplify the identification process of persons-of-interest, those skilled in the art have proposed the use of surveillance systems that are configured to automatically issue an alarm when illegal or prohibited activity takes place in a location under surveillance. When the alarm is issued, the exit routes of the area under surveillance are then automatically blocked or closed off to prevent the suspicious individuals from leaving the area thereby allowing them to be easily apprehended by the authorities. The main downside to this approach is that it only allows the suspicious individuals to be apprehended if they are stopped before they leave the area under surveillance. If the illegal activity is only detected a few days later after the persons-of-interest have left the area, a manual search process would still have to be carried out to obtain the identities of these persons-of-interest. Additionally, the approach proposed above only identifies an individual as a person-of-interest after an illegal activity has taken place. The proposal above does not anticipate or trigger the monitoring of an individual as a person-of-interest due to abnormal changes in the individual's daily habits or patterns.

For the above reasons, those skilled in the art are constantly striving to come up with a system and method that is able to automatically identify persons-of-interest based on their abnormal behaviour and abnormal activities. By identifying such persons-of-interest early on, such persons-of-interest may be monitored early thereby reducing the amount of time spent on such investigations.

### SUMMARY OF THE INVENTION

The above and other problems are solved and an advance in the art is made by systems and methods provided by embodiments in accordance with the invention.

A first advantage of embodiments of systems and methods in accordance with the invention is that the invention is able to automatically identify an individual as a person-of-interest based on a change in the individual's normal behaviour and based on the presence of the individual at a location-of-interest that is being monitored.

A second advantage of embodiments of systems and methods in accordance with the invention is that individuals who frequently visit a location under surveillance will be constantly monitored by the system, and as a result, any deviation from their normal routine and/or activity would then cause the system to flag these individuals as persons-of-interest.

A third advantage of embodiments of systems and methods in accordance with the invention is that the invention utilizes information about an individual as obtained from third party databases to determine if the individual's pattern has deviated from their normal pattern thereby allowing such persons-of-interest to be detected at an early stage.

A fourth advantage of embodiments of systems and methods in accordance with the invention is that the invention utilizes image capturing devices provided across multiple locations of interest to identify individuals that may possibly be considered as persons-of-interest thereby reducing the number of individuals that may be incorrectly classified as persons-of-interest.

The above advantages are provided by embodiments of a method in accordance with the invention operating in the following manner.

According to a first aspect of the invention, a system for identifying persons-of-interest is disclosed, the system comprising: an anomaly detection module configured to: retrieve data from a third party database; train an anomaly detection model using the retrieved data; retrieve new datasets from the third party database, whereby each newly retrieved dataset is associated with at least one individual; identify, using the trained anomaly detection model, anomalous patterns from the newly retrieved datasets; a person-of-interest (POI) identification module configured to: extract, from the anomalous patterns identified by the anomaly detection module, datasets associated with these anomalous patterns and information about individuals linked with these datasets; obtain, based on the retrieved information, captured images of the individuals and identification tags associated with each of the individuals, from image capturing devices provided at a first location-of-interest (LOI), whereby the identification tags are generated from the captured images of the individuals; identify, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

In accordance with the first aspect of the invention, the obtaining the captured images of the individuals and identification tags associated with each of the individuals further comprises the POI identification module being configured to: obtain, based on the retrieved information, captured images of the individuals and identification tags associated with each of the individuals, from image capturing devices provided at a second LOI, whereby the identification of the individuals from the captured images of the individuals and their associated identification tags further comprises the POI identification module being further configured to identify individuals having a frequency of occurrence at the first ad second LOIs that exceed a predetermined threshold and rank the identified individuals according to their frequency of occurrence, whereby identified individuals that exceed a predetermined rank are classified as persons-of-interest.

In accordance with the first aspect of the invention, the system further comprises: a prediction module communicatively connected to the anomaly prediction module, the prediction module being configured to: predict, using the trained anomaly model, a range of anomalous datasets, whereby newly retrieved datasets from the third party database that fall within the range of anomalous datasets are defined as anomalous patterns, wherein each newly retrieved dataset is associated with at least one individual.

In accordance with the first aspect of the invention, the identification tag associated with each of the individuals comprises a vehicular identification tag, a personal identification tag, temporal data associated with the individual or a facial tag associated with the individual.

In accordance with the first aspect of the invention, the data retrieved from the third party database comprises social media postings, mobile data usage patterns, geo-positional data or temporal data.

In accordance with the first aspect of the invention, the anomaly detection model comprises supervised machine learning algorithms or unsupervised machine learning algorithms.

In accordance with the first aspect of the invention, statistical models for outlier detection are used to predict the range of anomalous datasets.

According to a second aspect of the invention, a method for identifying persons-of-interest using an anomaly detection module, a third party database and a person-of-interest (POI) identification module is disclosed, the method comprising the following steps: retrieving, using the anomaly detection module, data from the third party database; training, using the anomaly detection module, an anomaly detection model using the retrieved data; retrieving, using the anomaly detection module, new datasets from the third party database, whereby each newly retrieved dataset is associated with at least one individual; identifying, using the trained anomaly detection model, anomalous patterns from the newly retrieved datasets; extracting, using the POI identification module, from the anomalous patterns identified by the anomaly detection module, datasets associated with these anomalous patterns and information about individuals linked with these datasets; obtaining, using the POI identification module, based on the retrieved information, captured images of the individuals and identification tags associated with each of the individuals, from image capturing devices provided at a first location-of-interest (LOI), whereby the identification tags are generated from the captured images of the individuals; identifying, using the POI identification module, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

In accordance with the second aspect of the invention, the obtaining, using the POI identification module, the captured images of the individuals and identification tags associated with each of the individuals further comprises the steps of: obtaining, using the POI identification module, based on the retrieved information, captured images of the individuals and identification tags associated with each of the individuals, from image capturing devices provided at a second LOI, whereby the identification of the individuals from the captured images of the individuals and their associated identification tags further comprises the POI identification module being further configured to identify individuals having a frequency of occurrence at the first ad second LOIs that exceed a predetermined threshold and rank the identified individuals according to their frequency of occurrence, whereby identified individuals that exceed a predetermined rank are classified as persons-of-interest.

In accordance with the second aspect of the invention, the method further comprises the step of predicting, using a prediction module communicatively connected to the anomaly prediction module together with the trained anomaly model, a range of anomalous datasets, whereby newly retrieved datasets from the third party database that fall within the range of anomalous datasets are defined as anomalous patterns, wherein each newly retrieved dataset is associated with at least one individual.

In accordance with the second aspect of the invention, the identification tag associated with each of the individuals comprises a vehicular identification tag, a personal identification tag, temporal data associated with the individual or a facial tag associated with the individual.

In accordance with the second aspect of the invention, the data retrieved from the third party database comprises social media postings, mobile data usage patterns, geo-positional data or temporal data.

In accordance with the second aspect of the invention, wherein the anomaly detection model comprises supervised machine learning algorithms or unsupervised machine learning algorithms.

In accordance with the second aspect of the invention, wherein statistical models for outlier detection are used to predict the range of anomalous datasets.

### BRIEF DESCRIPTION OF THE DRAWINGS

The above and other problems are solved by features and advantages of a system and method in accordance with the present invention described in the detailed description and shown in the following drawings.

FIG. 1 illustrating a block diagram of a system for identifying persons-of-interest in accordance with embodiments of the invention;

FIG. 2 illustrating a block diagram representative of processing systems providing embodiments in accordance with embodiments of the invention;

FIG. 3 illustrating a flow diagram of the identification of persons-of-interest in accordance with embodiments of the invention;

FIG. 4 illustrating a process for training an anomaly detection module and identifying anomalous patterns in accordance with embodiments of the invention; and

FIG. 5 illustrating a process for classifying individuals as persons-of-interest in accordance with embodiments of the invention.

### DETAILED DESCRIPTION

This invention relates to a system and method for identifying persons-of-interest based on images and/or information captured by image capturing devices and information provided by third party sources/databases. In particular, this invention relates to a system that comprises an anomaly detection module, a third party database and a person-of-interest (POI) module which are all communicatively connected together. The anomaly detection module is configured to train an anomaly detection model based on data retrieved from the third party database whereby the trained model is then subsequently used to identify anomalous patterns from datasets that are newly retrieved from the third party database. The POI module is then configured to extract from the anomalous patterns identified by the anomaly detection module, datasets associated with these anomalous patterns and information about individuals linked with these datasets. The POI modules then utilizes this information about the individuals, to obtain captured images of the individuals and identification tags associated with each of the individuals, from image capturing devices provided at a location-of-interest (LOI), whereby the identification tags are generated from the captured images of the individuals and then to identify, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

The present invention will now be described in detail with reference to several embodiments thereof as illustrated in the accompanying drawings. In the following description, numerous specific features are set forth in order to provide a thorough understanding of the embodiments of the present invention. It will be apparent, however, to one skilled in the art, that embodiments may be realised without some or all of the specific features. Such embodiments should also fall within the scope of the current invention. Further, certain process steps and/or structures in the following may not been described in detail and the reader will be referred to a corresponding citation so as to not obscure the present invention unnecessarily.

Further, one skilled in the art will recognize that many functional units in this description have been labelled as modules throughout the specification. The person skilled in the art will also recognize that a module may be implemented as circuits, logic chips or any sort of discrete component. Still further, one skilled in the art will also recognize that a module may be implemented in software which may then be executed by a variety of processors. In embodiments of the invention, a module may also comprise computer instructions or executable code that may instruct a computer processor to carry out a sequence of events based on instructions received. The choice of the implementation of the modules is left as a design choice to a person skilled in the art and does not limit the scope of this invention in any way.

FIG. 1 illustrates a block diagram of modules and/or various components that make up system 100 for identifying persons-of-interest in accordance with embodiments of the invention. System 100 comprises of locations-of-interest 105 and 115, person-of-interest (POI) module 130, anomaly detection module 135 and third party database 140.

A set of image capturing devices are provided at each of these locations-of-interest (LOI) and these image capturing devices are all communicatively connected to POI module 130 via wired and/or wireless means (e.g. Wi-Fi, 3G/4G/5G cellular networks, Bluetooth, etc.). As illustrated in FIG. 1, a set of image capturing devices 101a-d are provided at location-of-interest 105 and another set of image capturing devices 111a-c are provided at location-of-interest 115. The set of image capturing devices 101a-d are configured to capture moving and/or still images of target 110 and the set of image capturing devices 111a-c are configured to capture moving and/or still images of target 120. It should be noted that any number of image capturing devices may be provided at any of the locations-of-interest, including, but not limited to, just one image capturing device at each location, without departing from the invention. In embodiments of the invention, locations-of-interest may comprise locations such as, but not limited to, restricted areas/locations/buildings, public locations, a financial institution, or any location whereby malicious or suspicious activities may take place. As such, it would be of interest to the authorities to monitor the movement of individuals at these locations.

One skilled in the art will recognize that each image capturing device may comprise of any type of device/module that is able to capture still and/or moving images such as, but not limited to, a surveillance camera, a digital camera, a video camera, etc. and that these devices may be communicatively linked together to automatically focus on a single target so that still images and/or moving images of a target may be captured from multiple angles to obtain a complete view of the target.

Targets 110 and 120 may comprise of any movable objects that fall within the range of the image capturing devices, i.e. 101a-d or 111a-c respectively, and may comprise individuals, vehicles and/or any movable objects nearby. Once the images of targets 110 or 120 have been captured by the respective image capturing devices, identification tags will then be generated based on the captured images whereby each identification tag will be associated with an individual contained within the captured images. The identification tags associated with an individual may comprise, but are not limited to, facial tags that may be generated using facial recognition algorithms whereby each facial tag is generated based on a captured image of an individual; body tags that may be generated using body-based Person Re-Identification algorithms; vehicular identification tags such as a vehicle's license plates, a vehicle's make and/or model; and/or temporal data associated with the individual whereby the temporal data contains information such as the time and/or date that the image of the individual was captured. One skilled in the art will recognize that the identification tags associated with an individual may comprise any other feature or parameter that may be discerned from the captured images whereby this feature and/or parameter may be subsequently linked to the individual to assist in the identification of the individual.

The images captured by the image capturing devices and the generated identification tags associated with the individuals in the captured images may then be sent to POI module 130. POI module 130 may be provided in a cloud server, a local server or at a central command centre that is communicatively connected to the image capturing devices either through wired or wireless means.

As illustrated in FIG. 1, POI module 130 is also communicatively connected to anomaly detection module 135, which in turn is connected to third party database 140.

In embodiments of the invention, anomaly detection module 135 is configured to retrieve data and/or information from third party database 140. In embodiments of the invention, third party database 140 may comprise a computer server that is configured to crawl through the Internet to “scrape” social media websites, chatrooms, and any online media to obtain data or information about the individuals contained within the initial database. The “scraped” data may comprise photos belonging to/linked to/tagged to/shared by/associated various individual, postings made by various individuals, mobile data usage of various individuals, geo-positional and temporal data associated with various individuals. Third party database 140 may also obtain information about individuals from restricted servers such as servers belonging to mobile service providers and/or paid services.

The data and/or information obtained from third party database 140 is then used to train an anomaly detection model so that abnormal patterns may be detected amongst datasets that are newly obtained from third party database 140.

In embodiments of the invention, the information obtained from the third party database 140 may be used as the training data to train an anomaly detection model such as, but not limited to, a supervised learning model or an unsupervised learning model. Such learning models may comprise, but are not limited to, support-vector machines, linear regression, K-nearest neighbour algorithm, neural networks, decision trees, Naïve Bayes, auto-encoders, logistic regression and linear discriminant analysis. The anomaly detection model may also be trained using unsupervised methods with well-defined objective functions/loss functions. E.g. the model could be trained to learn the degree of dissimilarity between instances (for a person during a time) of data streams (e.g. movement trajectory, use of hate speech terms in social media posts).

In other embodiments of the invention, the information obtained from the third party database 140 may be used to train an anomaly detection model comprising a statistical outlier model to identify information/datasets that would result in normal patterns or otherwise. Examples of such statistical outlier models would comprise clustering techniques such K-means or multi-variate Gaussian distribution. Additionally, the anomaly detection model could be trained to identify dataset anomalies comprising observations which differ from the majority of the distribution (e.g. office goers have a similar travel pattern, tourist have a similar travel pattern, there could be such pre-dominant travel patterns, a trajectory which does not fit into such pre-dominant travel patterns could be a potential anomalous travel pattern). In certain embodiments of the invention, a pattern would be considered to have deviated from its normal pattern if the pattern resulted in abnormal travel routes, different transportation routes, prolonged periods in remote locations, abnormal postings on social media or carried out any other activities that deviated the normal distribution of such behaviours thereby producing abnormal spatial-temporal points in the time-series of the resulting pattern and its corresponding heuristics. One skilled in the art will recognize that this list of patterns are not exhaustive and is used as examples for illustrative purposes only.

Once the anomaly detection model has been trained using either one of the methods described above, the trained model would then be able to detect and/or identify datasets, newly retrieved from third party database 140, that have anomalous patterns. In particular, when datasets retrieved from third party database 140 are provided to the trained model, the trained model would be able to identify whether the retrieved datasets form anomalous patterns. It should be noted that the datasets retrieved from third party database 140 may be linked and/or associated with one or more individuals.

POI module 130 is then configured to extract, from the anomalous patterns identified by anomaly detection module 135, datasets associated with these anomalous patterns. Information about individuals linked with these datasets are then subsequently retrieved by POI module 130. Based on the retrieved information about these individuals that are linked with these datasets, POI module 130 will then obtain captured images of the individuals and identification tags associated with each of the individuals, from the sets of image capturing devices provided at location-of-interests (LOIs) 105 and/or 115, whereby the identification tags are generated from the captured images of the individuals (or as illustrated in FIG. 1, targets 110 and 120).

In an embodiment of the invention, POI module 130 only obtains captured images and identification tags associated with each of the individuals, from the set of image capturing devices provided at location-of-interest 105 or 106. In another embodiment of the invention, POI module 130 may be configured to obtain captured images and identification tags associated with each of the individuals, from the set of image capturing devices provided at two or more locations-of-interest and one skilled in the art will recognize that POI module 130 may utilize captured images and identification tags associated with each of the individuals from any number of locations-of-interest without departing from the invention.

POI module 130 then compiles information about individuals whose images have been captured at the location-of-interest or across multiple locations-of-interest. As part of the compilation process, POI module 130 will identify from the captured images of the individuals and their associated identification tags, individuals having a frequency of occurrence at the location-of-interest or multiple locations-of-interest that exceed a predetermined threshold and rank the identified individuals according to their frequency of occurrence, whereby identified individuals that exceed a predetermined rank are classified as persons-of-interest individuals. In summary, POI module 130 will identify individuals that have a frequency of occurrence at the location-of-interest or multiple locations-of-interest that is (are) higher than or exceeds a predetermined threshold/frequency. The identified individuals are then subsequently ranked according to their respective frequencies of occurrence whereby identified individuals that exceed a predetermined rank are classified by POI module 130 as persons-of-interest.

The main aim of doing so is to identify individuals who have been loitering around or potentially scouting out a location with the intent of carrying out malicious activities. Individuals whose images are constantly captured at the location of interest, i.e. images with high frequency of occurrences, may then be flagged for further processing. For example, if a location-of-interest comprises a financial institute, POI module 130 will then identify individuals that frequently appear at this location. POI module 130 may then be optionally configured to carry out a quick check with a database (not shown) to determine whether the individuals with a high frequency of occurrence are employees of the financial institute or regular customers of the financial institute. By doing so, POI module 130 would be able to further reduce the list of suspicious individuals. Another objective of doing so would be to identify abnormal travel patterns associated with certain individuals. For example, if the locations-of-interest comprise a financial institute and a nature reserve, the POI module would flag travel patterns between these two locations as anomalous or abnormal as these LOIs appear to be completely unrelated to each other.

Additionally, it should be noted that the value for the predetermined threshold and/or predetermined rank is left as a design choice for one skilled in the art as it will vary from one location to another. For example, at a public location such as the train station, the frequency of occurrence for an individual would be higher as there is the strong likelihood that the individual will frequent that location more often as compared to a restricted location such as a power station or a data centre.

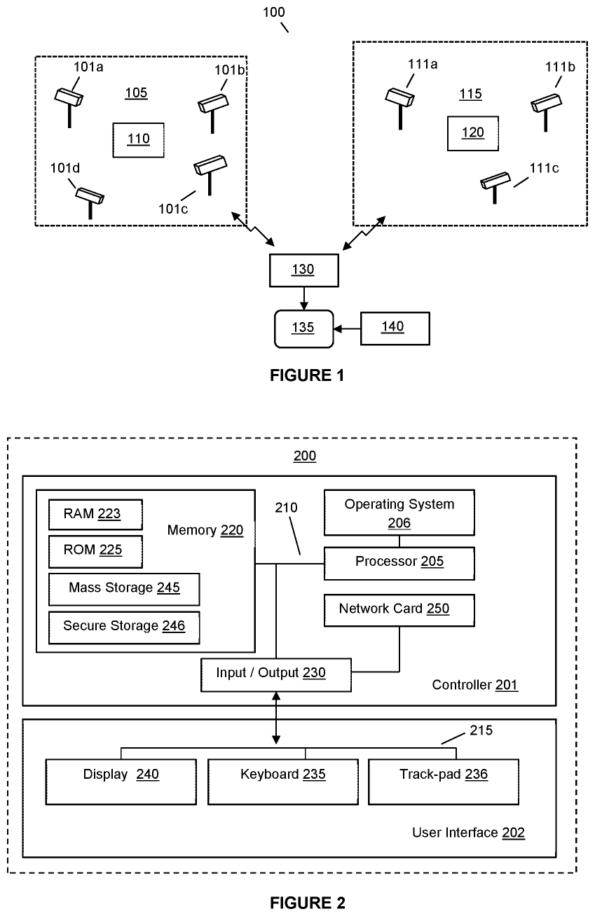

In accordance with embodiments of the invention, a block diagram representative of components of processing system 200 that may be provided within modules 130 and 135; in database 140 and in modules provided within each of the image capturing devices for implementing embodiments in accordance with embodiments of the invention is illustrated in FIG. 2. One skilled in the art will recognize that the exact configuration of each processing system provided within these modules may be different and the exact configuration of processing system 200 may vary and FIG. 2 is provided by way of example only.

In embodiments of the invention, each of modules 130 and 135; in database 140 and in modules provided within each of the image capturing devices may comprise controller 201 and user interface 202. User interface 202 is arranged to enable manual interactions between a user and each of these modules as required and for this purpose includes the input/output components required for the user to enter instructions to provide updates to each of these modules. A person skilled in the art will recognize that components of user interface 202 may vary from embodiment to embodiment but will typically include one or more of display 240, keyboard 235 and track-pad 236.

Controller 201 is in data communication with user interface 202 via bus 215 and includes memory 220, processor 205 mounted on a circuit board that processes instructions and data for performing the method of this embodiment, an operating system 206, an input/output (I/O) interface 230 for communicating with user interface 202 and a communications interface, in this embodiment in the form of a network card 250. Network card 250 may, for example, be utilized to send data from these modules via a wired or wireless network to other processing devices or to receive data via the wired or wireless network. Wireless networks that may be utilized by network card 250 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 220 and operating system 206 are in data communication with CPU 205 via bus 210. The memory components include both volatile and non-volatile memory and more than one of each type of memory, including Random Access Memory (RAM) 220, Read Only Memory (ROM) 225 and a mass storage device 245, the last comprising one or more solid-state drives (SSDs). Memory 220 also includes secure storage 246 for securely storing secret keys, or private keys. One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 220 may include a kernel and/or programming modules such as a software application that may be stored in either volatile or non-volatile memory.

Herein the term “processor” is used to refer generically to any device or component that can process such instructions and may include: a microprocessor, microcontroller, programmable logic device or other computational device. That is, processor 205 may be provided by any suitable logic circuitry for receiving inputs, processing them in accordance with instructions stored in memory and generating outputs (for example to the memory components or on display 240). In this embodiment, processor 205 may be a single core or multi-core processor with memory addressable space. In one example, processor 205 may be multi-core, comprising—for example—an 8 core CPU. In another example, it could be a cluster of CPU cores operating in parallel to accelerate computations.

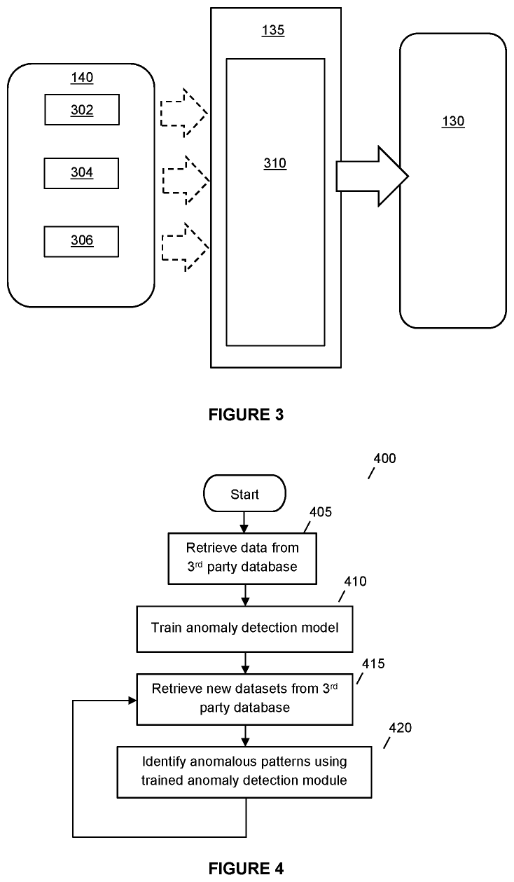

FIG. 3 illustrates a flow diagram of the identification of persons-of-interest in accordance with embodiments of the invention. As shown in FIG. 3, anomaly detection module 135 retrieves data/information from third party database 140 to train anomaly detection model 310, that is provided within module 135. In accordance with embodiments of the invention, the data/information retrieved from third party database 140 may comprise, but are not limited to, geo-positional and/or temporal data 302, social media data 304 and images 306. Once trained, trained anomaly detection model 310′ (not shown) may then be configured to continuously retrieve new datasets from third party database 140. As mentioned in the previous sections, these newly retrieved datasets would be linked to one or more individuals. Trained anomaly detection model 310′ will then identify, from the newly retrieved datasets, datasets that form anomalous patterns. Datasets that form these anomalous patterns are then provided to POI module 130.

POI module 130 will then extract, from the datasets that formed the anomalous patterns, information about individuals linked with these datasets. Captured images of the individuals and identification tags associated with each of the individuals will then be obtained by POI module 130 from image capturing devices provided at one or more locations-of-interest (LOI), whereby the identification tags are generated from the captured images of the individuals. Based from the captured images of the individuals and their associated identification tags, POI module 130 then identifies individuals having a frequency of occurrence at the one or more LOIs that exceed a predetermined threshold. These identified individuals are then ranked according to their frequency of occurrence at the one or more LOIs, whereby identified individuals that exceed a predetermined rank are classified as persons-of-interest.

In other embodiments of the invention, a prediction module (not shown) may be communicatively connected to the anomaly prediction module. The prediction module may be configured to predict, using trained anomaly model 310′, a range of anomalous datasets, whereby newly retrieved datasets from third party database 140 that fall within the range of anomalous datasets are defined as anomalous patterns, wherein each newly retrieved dataset is associated with at least one individual. The prediction module may be trained based on existing historical travel patterns and data points obtained from previously confirmed suspicious incidents (e.g. a reported terrorist incident) and as a result, corresponding outlier/anomalous patterns could be predicted. In other embodiments of the invention, the prediction model used may comprise machine learning/deep learning techniques which introduce noise to create variants of such incidents and may comprise, but are not limited to techniques such as Generative and Adversarial Networks (GAN), and/or Game theory. These range of predicted patterns could then be used to show the end user the possibilities as well as be used to train the model even further. E.g. of variants, original suspicious pattern involves train mode of transport, variant involves traveling by car

FIG. 4 sets out an exemplary flowchart of process 400 for training an anomaly detection model and using the trained model to identify anomalous patterns in accordance with embodiments of the invention. It should be noted that process 400 may be carried out by anomaly detection module 135. Process 400 begins at step 405 whereby data/information are retrieved from a third party database. This retrieved data/information is then used by process 400 at step 410 to train an anomaly model. Process 400 then proceeds to retrieve new datasets from the third party database at step 415 whereby these newly retrieved datasets are associated with at least an individual. At step 420, process 400 then utilizes the trained anomaly detection model to identify anomalous patterns from the newly retrieved datasets. Process 400 then proceeds to step 415. Steps 415-420 continuously repeat such that new datasets are continuously retrieved and provided to the trained anomaly detection model and the trained anomaly detection model constantly processes the newly retrieved datasets to identify anomalous patterns from these datasets.

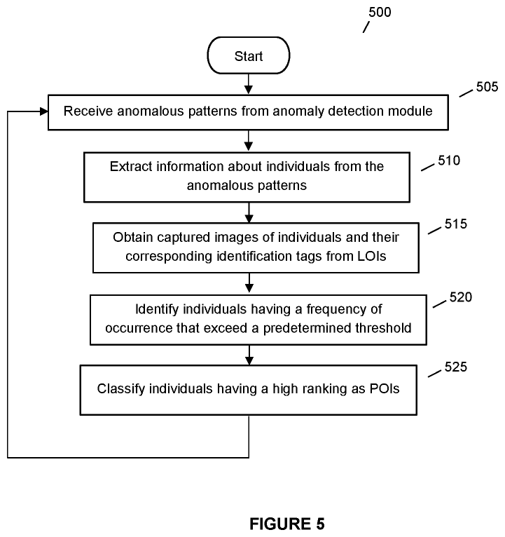

FIG. 5 sets out an exemplary flowchart of process 500 for classifying individuals as persons-of-interest by POI module 130 based on the anomalous patterns identified by the anomaly detection module, datasets associated with these anomalous patterns and information about individuals linked with these datasets. Process 500 begins at step 505 whereby the anomalous patterns and their corresponding datasets are received from the anomaly detection module. At step 510, process 500 then extracts information about the individuals that are associated with the datasets. Based on the extracted information, process 500 then obtains captured images of the relevant individuals and their corresponding identification tags from image capturing devices provided at one or more locations-of-interest. This takes place at step 515. At step 520, process 500 then identifies individuals that have a high frequency of occurrence (i.e. exceeds a predetermined threshold) at the one or more locations-of-interest. Process 500, at step 525, then classifies from this group of identified individuals, individuals that are ranked with a high frequency of interest as persons-of-interest. Process 500 then returns to step 505 to receive anomalous patterns and their corresponding datasets from the anomaly detection module. Steps 510-525 then repeats itself.

Numerous other changes, substitutions, variations and modifications may be ascertained by the skilled in the art and it is intended that the present invention encompass all such changes, substitutions, variations and modifications as falling within the scope of the appended claims.

1. A system for identifying persons-of-interest, the system comprising:
an anomaly detection module configured to:
retrieve data from a third party database;
train an anomaly detection model using the retrieved data;
retrieve new datasets from the third party database, whereby each newly retrieved dataset is associated with at least one individual;
identify, using the trained anomaly detection model, anomalous patterns from the newly retrieved datasets;
a person-of-interest (POI) identification module configured to:
extract, from the anomalous patterns identified by the anomaly detection module, datasets associated with these anomalous patterns and information about individuals linked with these datasets;
obtain, based on the retrieved information, captured images of the individuals and identification tags associated with each of the individuals, from image capturing devices provided at a first location-of-interest (LOI), whereby the identification tags are generated from the captured images of the individuals;
identify, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

2. The system according to claim 1 wherein the obtaining the captured images of the individuals and identification tags associated with each of the individuals further comprises the POI identification module being configured to:
obtain, based on the retrieved information, captured images of the individuals and identification tags associated with each of the individuals, from image capturing devices provided at a second LOI,
whereby the identification of the individuals from the captured images of the individuals and their associated identification tags further comprises the POI identification module being further configured to identify individuals having a frequency of occurrence at the first ad second LOIs that exceed a predetermined threshold and rank the identified individuals according to their frequency of occurrence, whereby identified individuals that exceed a predetermined rank are classified as persons-of-interest.

3. The system according to claim 1 further comprising:
a prediction module communicatively connected to the anomaly prediction module, the prediction module being configured to:
predict, using the trained anomaly model, a range of anomalous datasets, whereby newly retrieved datasets from the third party database that fall within the range of anomalous datasets are defined as anomalous patterns, wherein each newly retrieved dataset is associated with at least one individual.

4. The system according to claim 1, wherein the identification tag associated with each of the individuals comprises a vehicular identification tag, a personal identification tag, temporal data associated with the individual or a facial tag associated with the individual.

5. The system according to claim 1, wherein the data retrieved from the third party database comprises social media postings, mobile data usage patterns, geo-positional data or temporal data.

6. The system according to claim 1, wherein the anomaly detection model comprises supervised machine learning algorithms or unsupervised machine learning algorithms.

7. The system according to claim 3, wherein statistical models for outlier detection are used to predict the range of anomalous datasets.

8. A method for identifying persons-of-interest using an anomaly detection module, a third party database and a person-of-interest (POI) identification module, the method comprising:
retrieving, using the anomaly detection module, data from the third party database;
training, using the anomaly detection module, an anomaly detection model using the retrieved data;
retrieving, using the anomaly detection module, new datasets from the third party database, whereby each newly retrieved dataset is associated with at least one individual;
identifying, using the trained anomaly detection model, anomalous patterns from the newly retrieved datasets;
extracting, using the POI identification module, from the anomalous patterns identified by the anomaly detection module, datasets associated with these anomalous patterns and information about individuals linked with these datasets;
obtaining, using the POI identification module, based on the retrieved information, captured images of the individuals and identification tags associated with each of the individuals, from image capturing devices provided at a first location-of-interest (LOI), whereby the identification tags are generated from the captured images of the individuals;
identifying, using the POI identification module, from the captured images of the individuals and their associated identification tags, individuals having a frequency of occurrence at the first LOI that exceed a predetermined threshold and rank the identified individuals according to their frequency of occurrence, whereby identified individuals that exceed a predetermined rank are classified as persons-of-interest.

9. The method according to claim 8 wherein the obtaining, using the POI identification module, the captured images of the individuals and identification tags associated with each of the individuals further comprises the steps of:
obtaining, using the POI identification module, based on the retrieved information, captured images of the individuals and identification tags associated with each of the individuals, from image capturing devices provided at a second LOI,
whereby the identification of the individuals from the captured images of the individuals and their associated identification tags further comprises the POI identification module being further configured to identify individuals having a frequency of occurrence at the first and second LOIs that exceed a predetermined threshold and rank the identified individuals according to their frequency of occurrence, whereby identified individuals that exceed a predetermined rank are classified as persons-of-interest.

10. The method according to claim 8 further comprising:
predicting, using a prediction module communicatively connected to the anomaly prediction module together with the trained anomaly model, a range of anomalous datasets, whereby newly retrieved datasets from the third party database that fall within the range of anomalous datasets are defined as anomalous patterns, wherein each newly retrieved dataset is associated with at least one individual.

11. The method according to claim 8, wherein the identification tag associated with each of the individuals comprises a vehicular identification tag, a personal identification tag, temporal data associated with the individual or a facial tag associated with the individual.

12. The method according to claim 8, wherein the data retrieved from the third party database comprises social media postings, mobile data usage patterns, geo-positional data or temporal data.

13. The method according to claim 8, wherein the anomaly detection model comprises supervised machine learning algorithms or unsupervised machine learning algorithms.

14. The method according to claim 10, wherein statistical models for outlier detection are used to predict the range of anomalous datasets.
